(19) United States
(12) Patent Application Publication
(10) Pub. No.: US 2022/0179810 A1
(43) Pub. Date: Jun. 9, 2022

(54) METHOD FOR MANAGING THE OPERATION OF A SYSTEM ON CHIP, FOR EXAMPLE A MICROCONTROLLER, AND CORRESPONDING SYSTEM ON CHIP

(71) Applicant: STMicroelectronics (Rousset) SAS, Rousset (FR)

(72) Inventors: Sandrine LENDRE, Pourrieres (FR); Herve CASSAGNES, Salon-de-Provence (FR)

(73) Assignee: STMicroelectronics (Rousset) SAS, Rousset (FR)

(21) Appl. No.: 17/539,797

(22) Filed: Dec. 1, 2021

(30) Foreign Application Priority Data
Dec. 3, 2020 (FR) 2012630

(51) Int. Cl. G06F 13/28

(52) U.S. Cl. CPC G06F 13/28; G06F 2213/28

(57) ABSTRACT

A system on chip (SoC) includes a system clock device configured to generate at least one system clock signal, a first area with a central processing unit and a second area with a direct memory access (DMA) circuit, a peripheral coupled to the DMA circuit, and a memory containing peripheral configuration descriptor(s) executable by the DMA circuit. In a first mode of SoC operation, the system clock device delivers the system clock signal to all areas. In a second mode of SoC operation, the system clock device does not deliver the system clock signal to any area. In a third mode of SoC operation, the system clock device distributes the system clock signal to a part of the second area without delivering the system clock signal to the other areas and the DMA circuit configures the peripheral in response to the execution of the configuration descriptor(s).

### PRIORITY CLAIM

This application claims the priority benefit of French Application for Patent No. 2012630, filed on Dec. 3, 2020, the content of which is hereby incorporated by reference in its entirety to the maximum extent allowable by law.

### TECHNICAL FIELD

Implementations and embodiments relate to microelectronics and, in particular, the management of the operation of systems on chip (SOC), for example of microcontrollers, and furthermore the management of power consumption.

### BACKGROUND

Systems on chip, in particular microcontrollers, include many elements, in particular a central processing unit (CPU), for example a processor or a microprocessor, one or more direct memory access (DMA) circuits, memories, and peripherals, for example interfaces that can be of different types, for example interfaces supporting the Inter Integrated Circuit (I²C) communication protocol, the Serial Peripheral Interface (SPI) communication protocol, and Universal Asynchronous Receiver Transmitter (UART) type interfaces. All of these elements are generally connected to a system bus, for example of the Advanced Microcontroller Bus Architecture (AMBA) type.

The system on chip also includes a system clock device capable of generating a system clock signal for the system on chip.

The system on chip power consumption is a key parameter, especially for battery-powered systems on chip.

Usually, such a system on chip has two modes of operation, namely a mode of operation called “active” mode of operation wherein the system bus and the system clock are active, the central processing unit configures the peripherals and the direct memory access circuit(s) perform data transfers.

The system on chip also has a mode called “low power” mode wherein the system bus and system clock are turned OFF with limited peripheral functionalities.

To save power, the system on chip can enter its low power mode and switch back to its active mode when necessary, for example whenever a reconfiguration of a device is necessary and the clock system is required by the direct memory access circuit to perform a data transfer.

However, this switching from low power mode to active mode leads to an increase in consumption as well as a loss of performance of the central processing unit, in particular in terms of bandwidth, due to the interruption signals emitted by the peripherals for delivery to this central processing unit.

There is therefore a need to provide a management of a system on chip, for example a microcontroller, allowing a saving in power consumption and a saving in bandwidth for the central processing unit of the system on chip.

### SUMMARY

According to one implementation and embodiment, it is proposed in particular to provide for the system on chip, a third mode of operation different from the first mode of operation (referred to as the “active mode”) and from the second mode of operation (referred to as the “low power” mode applicable to the entire system on chip), this third mode of operation being a local active mode for at least one particular area of the system on chip allowing the other areas of the system on chip to remain in their “low power” mode.

The area which will be locally “woken up” includes a direct memory access circuit (DMA) which will, in particular, be able to reconfigure one or more peripherals of this woken area, whereas in the prior art, only a direct peripheral memory access circuit data transfer was possible in “low power” mode and a peripheral reconfiguration required switching back to the active mode.

According to one aspect, provision is made of a system on chip, for example a microcontroller, including: a system clock device configured to generate at least one system clock signal; a first area including at least one central processing unit; and at least one second area including at least one direct memory access circuit, a peripheral coupled to the direct memory access circuit and a memory containing at least one configuration descriptor of said peripheral and executable by the direct memory access.

The second area is distinct from the first area.

Here, the notion of area has a very general meaning.

Thus, generally, a designer of a microcontroller partitions the microcontroller into several domains including, for example, a domain called the central processing unit (CPU) domain which may for example, in turn, include a direct memory access circuit.

And, an area can be an entire system on chip domain or a subdomain of a system on chip domain.

Thus, if the CPU domain includes, in addition to the central processing unit, a direct memory access circuit and one or more peripherals, the first area may be the subdomain including the central processing unit and the second area the subdomain of the CPU domain including the direct memory access circuit and the peripheral(s) coupled to this direct memory access circuit.

A descriptor is a DMA data transfer structure programmed into direct memory access circuit registers and typically loaded from memory where that descriptor may be stored.

However, it is possible that, for example, a descriptor is directly loaded into registers of the direct memory access circuit when the system on chip is initialized.

For example, a descriptor defines one or more actions that can be executed by the direct memory access circuit when the descriptor information is loaded into the registers of the direct memory access circuit.

The system on chip according to this aspect has a first mode of operation wherein the system clock device delivers the system clock signal to all areas. This first mode of operation is therefore an active mode.

The system on chip has a second mode of operation wherein the system clock device does not deliver the system clock signal to any area. This second mode of operation is therefore an overall “low power” mode.

The system on chip moreover has a third mode of operation wherein the system clock device distributes the system clock signal to at least part of the second area without delivering the system clock signal to the other areas and wherein the direct memory access circuit is able to configure said peripheral in response to the execution of said configuration descriptor.

This third mode of operation is therefore a local active mode, all the other areas remaining in their “low power” mode.

Moreover, unlike the prior art, the direct memory access circuit is able to configure or reconfigure a peripheral without it being necessary for this to “wake up” a central processing unit.

According to one embodiment, the system on chip is configured to switch from its second mode of operation to its third mode of operation in the presence of a system clock signal request emitted by one of the elements of the second area.

And, the system on chip is advantageously configured to switch back to its second mode of operation upon the disappearance of any system clock signal request in the second area.

This further contributes to energy savings.

According to one embodiment, the memory can contain several descriptors, each descriptor containing a request indication, which is programmable, designating, for this descriptor, the peripheral of the second area capable of transmitting a request to the direct memory access circuit.

Likewise, each descriptor can contain a first trigger indication, which is programmable, indicating whether or not the execution of this descriptor can be triggered by a trigger signal external to the direct memory access circuit, originating for example from a peripheral of the second area.

Furthermore, each descriptor can also contain a second trigger indication, which is programmable, designating for this descriptor, the peripheral of the second area capable of transmitting the trigger signal allowing to trigger the execution of the descriptor.

Thus, with these different indications, which are programmable, for example by the user, according to the application considered for the system on chip, it is possible to provide for the execution of complex scenarios, including reconfigurations of peripherals, for example, as well as selections of peripherals, while leaving other areas of the system on chip in their low power mode.

The memory can also be configured to store a list of several linked descriptors, sequentially addressable by the direct memory access circuit, and respectively representative of actions to be performed by the direct memory access circuit.

This list can contain said at least one reconfiguration descriptor.

Moreover, when the memory contains several descriptors, the system clock device is configured in the third mode of operation, in the presence of the system clock signal request emitted by one of the elements of the second area, to distribute the system clock signal to all the elements of this second area concerned by said descriptors.

Thus, the direct memory access circuit can access all concerned peripherals and not just the one requiring the system clock signal.

This contributes, with the programming of the different indications of requests and of triggering descriptors, which are programmable, to the development of complex implementation scenarios which are locally executable by leaving the other areas in their low power mode, even when a list is present because the direct memory access circuit will have access, without loss of time, to all the concerned elements of the second area which will have already received the system clock signal.

A list of descriptors can include selections of peripheral requests or selections called “memory-to-memory” selections (that is to say configurations wherein the direct memory access circuit extracts, for example, a datum from the memory to store it in one of these registers) as well as trigger selections.

According to one embodiment, in the third mode of operation, the direct memory access circuit can be configured to trigger the sequential execution of the linked descriptors in response to the trigger signal triggering the execution of the first descriptor of the list.

The direct memory access circuit can have multiple processing channels and in this case, all descriptors can be assigned to a single channel or to several different channels.

Although it is possible to provide a further memory separate from the memory to contain data to be written or read respectively originating from or intended for at least one peripheral of the second area, it may be advantageous for the memory which contains at least some of the descriptors, to be also intended to contain these data to be written or read respectively originating from or intended for at least one peripheral of the second area.

As a non-limiting example, the second area can comprise at least one peripheral including an interface of the I²C type, a means (for example, but in a non-limiting manner, to a timer, an input output port, a comparator, a means delivering an asynchronous signal, . . . ) configured to deliver at least one trigger signal and possibly to deliver, periodically or not, several trigger signals.

And, the memory contains a list of linked descriptors comprising: a first configuration descriptor intended to configure the I²C interface in a first direction of transmission (for example in the direction of emission); a second descriptor intended to transfer data from the memory to the I²C interface or vice versa depending on the first direction of transmission; a third configuration descriptor intended to configure the I²C interface in a second direction of transmission (for example in reception); and a fourth descriptor intended to transfer data from the I²C interface to the memory or vice versa depending on the second direction of transmission.

And, the first descriptor of this list can, for example, be triggered in the presence of each trigger signal emitted by the timer.

According to another aspect, provision is made of a method for managing the operation of a system on chip, for example a microcontroller.

The system on chip includes: a system clock device configured to generate at least one system clock signal; a first area including at least one central processing unit, for example a processor or a microprocessor; and at least one second area including at least one direct memory access circuit, a peripheral coupled to the direct memory access circuit, and memory containing at least one configuration descriptor of said peripheral and executable by the direct memory access circuit.

The method according to this aspect selectively comprises placing a system on chip: in a first mode of operation wherein the system clock device delivers the system clock signal to all areas; or else in a second mode of operation wherein the system clock device does not deliver the system clock signal to any area; or else in a third mode of operation wherein the system clock device distributes the system clock signal to at least part of the second area without delivering the system clock signal to the other areas and wherein the direct memory access circuit configures said peripheral in response to the execution of said configuration descriptor.

According to one implementation, the method comprises switching from the second mode of operation to the third mode of operation in the presence of a system clock signal request emitted by one of the elements of the second area.

According to one implementation, the method comprises returning to the second mode of operation upon the disappearance of any system clock signal request in the second area.

According to one implementation, the memory contains several descriptors and the method comprises, for each descriptor, programming a request indication designating, for this descriptor, the peripheral of the second area capable of transmitting a request to the direct memory access circuit.

According to one implementation, the method further comprises programming for each descriptor a first trigger indication indicating whether the execution of this descriptor may or may not be triggered by a trigger signal external to the direct memory access circuit.

According to one implementation, the method further comprises programming for each descriptor a second trigger indication designating, for this descriptor, the peripheral of the second area capable of transmitting the trigger signal allowing the execution of the descriptor to be triggered.

According to one implementation, the method comprises storing in the memory a list of several linked descriptors sequentially addressable by the direct memory access circuit and respectively representative of actions to be executed by the direct memory access circuit.

Said list contains, for example, said at least one reconfiguration descriptor.

According to one implementation, the memory contains several descriptors and the method comprises in the third mode of operation, in the presence of the system clock signal request emitted by one of the elements of the second area, distributing the system clock signal to all the elements of this second area concerned by said descriptors.

According to one implementation, the method comprises in the third mode of operation, triggering by the direct memory access circuit the sequential execution of the linked descriptors in response to the trigger signal triggering the execution of the first descriptor of the list.

According to one implementation, the direct memory access circuit has several channels, and the method comprises assigning all the descriptors to a single channel or to several different channels.

According to one implementation, the method comprises storing in the memory data to be written or read, respectively originating from or intended for at least one peripheral of the second area.

### BRIEF DESCRIPTION OF THE DRAWINGS

Other advantages and features of the invention will become apparent upon examining the detailed description of implementations and embodiments, which are in no way limiting, and of the appended drawings wherein:

FIG. 1 is a block diagram of a system on chip;

FIG. 2 is a block diagram of a direct memory access circuit;

FIG. 3 is a block diagram of a memory circuit;

FIG. 4 illustrates steps of a method;

FIG. 5 is a block diagram of a system on chip;

FIG. 6 is a block diagram of a memory with stored descriptors;

FIGS. 7-8 illustrate executions of the actions associated with a given descriptor;

FIG. 9 is a block diagram of a system on chip;

FIG. 10 is a block diagram of a memory with stored descriptors; and

FIG. 11 illustrates execution of the actions associated with the descriptors.

### DETAILED DESCRIPTION

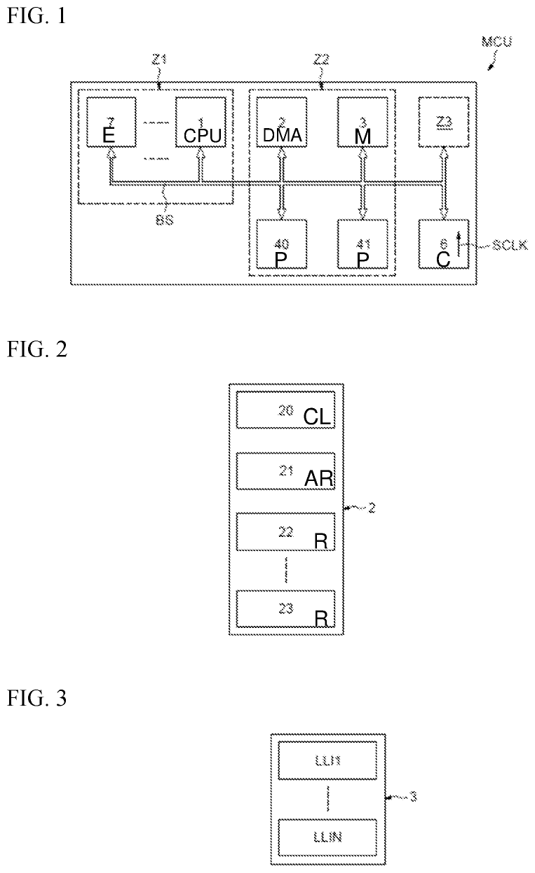

In FIG. 1, the reference MCU designates a system on chip, here a microcontroller, including several areas Z1, Z2, Z3.

The first area Z1 includes a central processing unit (CPU) 1, for example a processor, and other elements (E) 7.

The second area Z2, distinct from the first area Z1, includes a direct memory access (DMA) circuit 2, of conventional structure and known per se, a memory (M) 3, for example a static random access memory (SRAM) and several peripherals (P) two of which are shown here under the references 40 and 41.

The microcontroller can also include other areas, for example a third area Z3.

It will be seen in more detail below that in this exemplary embodiment, the second area Z2 is a particular area which can be locally “woken up” while the other areas will remain in a low power mode.

The microcontroller MCU also includes a clock generation device (C) 6, of conventional structure known per se, configured to generate a system clock signal SCLK.

This system clock signal can be delivered in a controlled manner, for example by means of clock gating cells, to the various elements of the microcontroller.

The microcontroller also includes a system bus BS.

Of course, the microcontroller MCU can include other elements not shown here for the purposes of simplification, such as, for example, an interconnection circuit known to the person skilled in the art under the name of “interconnect” allowing to route transactions between master equipment and slave equipment of the microcontroller.

Areas Z1 and Z2 can be two domains of the microcontroller or two subdomains of the same domain. Area Z3 can also be a domain or a subdomain of the microcontroller.

The structure of a direct memory access circuit 2 is well known to the person skilled in the art and includes in particular, as illustrated in FIG. 2, a control logic (CL) 20, an address register (AR) 21 and several registers intended to contain data, for example in this case indications contained in descriptors stored in the memory 3.

These descriptors can for example contain request indications, designating for the concerned descriptors, the peripheral(s) of the second area capable of transmitting a request to the direct memory access circuit 2.

Each descriptor can also contain a first trigger indication indicating whether or not the execution of this descriptor can be triggered by a trigger signal external to the direct memory access circuit.

Each descriptor may further contain a second trigger indication, designating for this descriptor, the peripheral of the second area capable of transmitting the trigger signal allowing to trigger the execution of the descriptor.

All these indications can be loaded into the registers (R) 22, 23 of the direct memory access circuit 2 from the memory 3.

All these indications are programmable, for example by the user of the microcontroller depending on the intended application and the scenarios to be executed locally in the second area Z2 while the other areas of the microcontroller are in low power mode.

Among the descriptors which can be stored in the memory 3, consideration is made of one or more lists of linked descriptors LLI1-LLIN which are shown schematically illustrated in FIG. 3.

The linked descriptors of a list are sequentially addressable by the direct memory access circuit and respectively representative of actions to be executed by the direct memory access circuit.

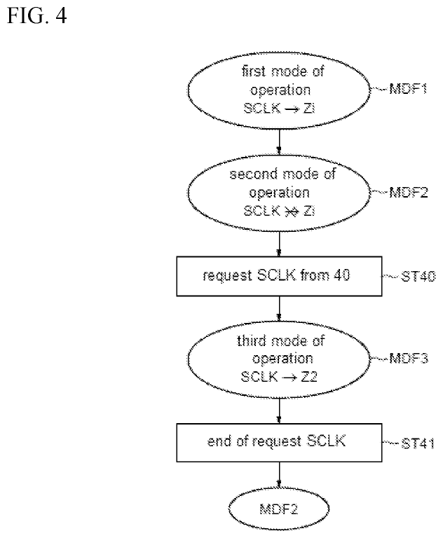

As schematically illustrated in FIG. 4, the system on chip has a first mode of operation MDF1 wherein the system clock device delivers the system clock signal SCLK to all areas Zi.

This first mode of operation is a mode called “active” mode.

The system on chip moreover has a second mode of operation (or “low power” mode) wherein the system clock device does not deliver the system clock signal SCLK to any area Zi and all areas Zi are in their low power mode.

Moreover, the system on chip includes a third mode of operation MDF3 wherein the system clock device distributes the system clock signal SCLK to at least part of the second area Z2, and more particularly, as will be seen more in detail below, to all the elements of this second area concerned by the execution of descriptors, and without delivering the system clock signal to the other areas or to the other elements of the second area not concerned by the descriptors.

This third mode of operation is therefore an active mode located in the concerned area, in this case the second area Z2, the other areas remaining in their low power mode.

As indicated above, a particularly simple way of controlling the distribution of the clock signal can consist of using clock gating cells receiving on the one hand the clock signal SCLK, and on the other hand, a logic signal originating from a bit of a register assigned to each element of the second area. If, for example, this bit is 1, the system clock device delivers the clock signal SCLK to the element under consideration, and if it is zero, for example, it does not deliver it.

And, the bits of this register are programmable, for example by the user according to the descriptors used.

As illustrated in FIG. 4, it is possible to switch from the second mode of operation MDF2 to the third mode of operation MDF3 in the presence of a request (step ST40) of the system clock signal SCLK emitted by one of the elements of the second area, for example the peripheral 40.

And it will then be seen in more detail below that the system clock signal is advantageously distributed to all the elements of the second area designated by the associated descriptors.

Moreover, as illustrated by step ST41, the system on chip may return to the second mode of operation MDF2 upon the disappearance of any system clock signal requests in the second area.

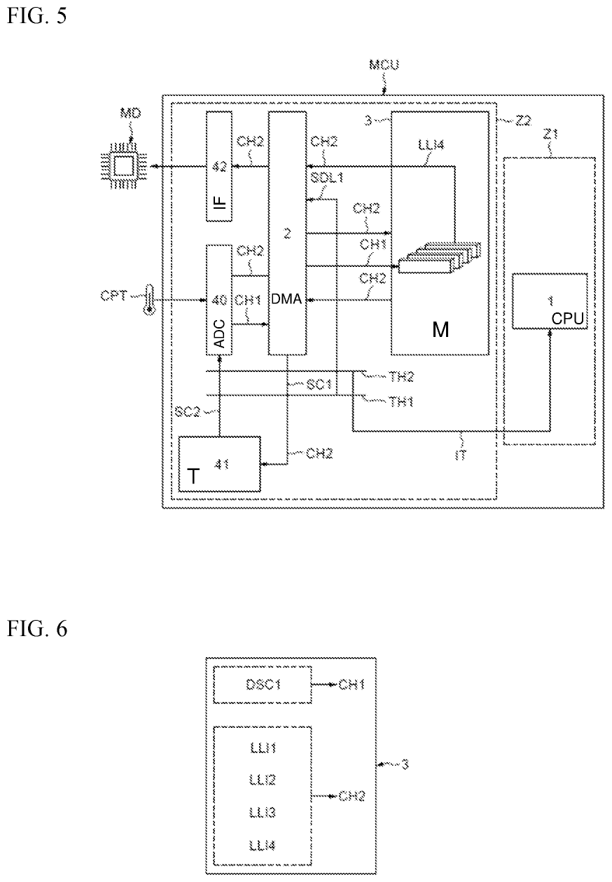

Reference is now made more particularly to FIGS. 5 to 8 to illustrate an example of implementation of embodiments.

In FIG. 5, it is assumed that the second area Z2 of the microcontroller MCU includes, in addition to the direct memory access circuit 2 and the memory 3, an analog-to-digital converter (ADC) 40, a timer (T) 41 and an SPI type interface (IF) 42 connected to an external module MD by a bus supporting the SPI protocol.

The first area Z1 contains the central processing unit 1.

In this example, the analog-to-digital converter 40 is connected to a temperature sensor CPT and is configured to convert at regular intervals the analog data delivered by the sensor CPT.

The analog-to-digital converter 40 converts the analog data into digital data at the rate of a control signal SC2 periodically delivered by the timer 41, in turn clocked by a clock signal of its own and which typically has a frequency which is lower than the frequency of the system clock signal.

On the other hand, when the analog-to-digital converter 40 is ready to transmit a datum to the direct memory access circuit 2, it must then use the system clock signal SCLK.

In this example, as shown in FIG. 6, the direct memory access circuit 2 has two processing channels CH1 and CH2. It is assumed here that the memory 3 stores a descriptor DSC1 associated with the first channel CH1 and a list of four linked descriptors LLI1-LLI4 associated with the second channel CH2.

The first descriptor DSC1 relates to the transfer of the digital data converted by the converter 40 to the memory 3.

This descriptor is transferred from the memory 3 into the registers of the direct memory access circuit 2 in order, in particular, to define the storage addresses.

The first descriptor LLI1 of the linked list processed by the second channel CH2 of the direct memory access circuit 2 is a reconfiguration descriptor allowing to increase the threshold value of the analog-to-digital converter.

More specifically, initially, a first threshold value TH1 is defined, for example 80° C. And, when the curve of the values delivered by the temperature sensor CPT reaches this threshold value TH1, then provision is made to modify this first threshold value TH1 into a second threshold value TH2 having, for example, the value of 100° C.

And, this first descriptor LLI1 also includes a trigger indication indicating that it can be triggered.

Furthermore, it includes a second trigger indication specifying that it can be triggered by the analog-to-digital converter when the first threshold value TH1 is reached.

These two trigger indications are intended to be stored in registers 22 of the direct memory access circuit 2.

And the execution of this first descriptor LLI1 is triggered by the delivery of the trigger signal SDL1 (FIG. 5) emitted by the analog-to-digital converter 40.

The second descriptor LLI2 of this chain is a descriptor controlling the emission by the analog-to-digital converter 40 of an interruption IT intended to wake up the central processing unit 1 when the curve of analog values reaches the second threshold value TH2.

More specifically, the execution of this second descriptor LLI2 includes writing in an interruption register of the converter 40 an indication providing for emitting said interruption IT when the threshold value TH2 is reached.

The third descriptor LLI3 of this linked list is again a reconfiguration descriptor intended this time to reconfigure the timer 41 so as to increase the sampling frequency of the converter 40, that is to say to increase the delivery frequency of the signal SC2.

Finally, the fourth descriptor of the linked list is the descriptor allowing to execute the transfer of the digital data which has been delivered by the analog-to-digital converter 40 and stored in the memory 3 to the interface 42 for purposes of transmission on the SPI bus to the external module MD.

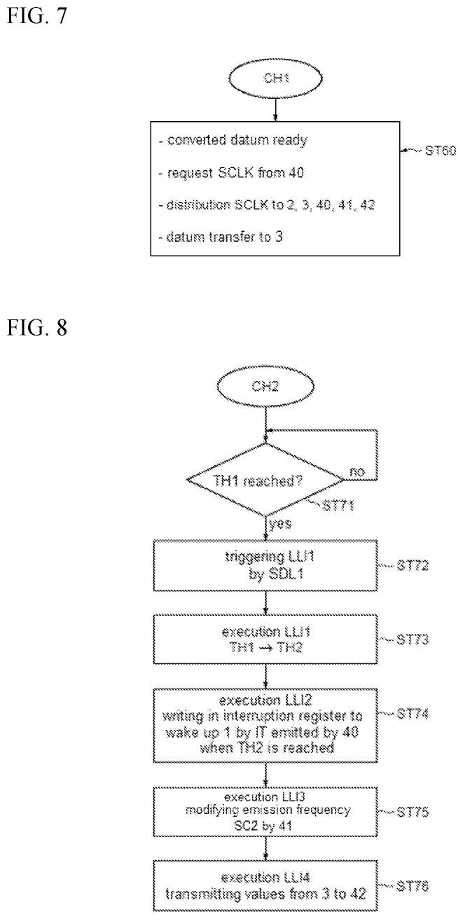

The execution of the actions associated with the descriptor DSC1 on the channel CH1 and with the descriptors LLI1-LLI4 on the channel CH2 is schematically described in FIGS. 7 and 8.

As illustrated in FIG. 7, in step ST60, as soon as an analog datum converted into a digital datum is ready to be transferred to the direct memory access circuit 2 for its storage in the memory 3, the analog-to-digital converter 40 emits a system clock signal SCLK request.

This clock signal SCLK is then distributed here to all the elements of the second area, namely not only to the analog-to-digital converter 40, but also to the direct memory access circuit 2, to the memory 3, to the timer 41 and to the interface 42 because all these elements will be concerned by the execution of the descriptors DSC1, LLI1, LLI2, LLI3 and LLI4.

Then, the converted digital datum is then transferred to the memory 3 via the direct memory access circuit 2 to the storage address contained in the address register 21 of the direct memory access circuit 2.

Regarding the channel CH2, as long as the values delivered by the temperature sensor do not reach the first threshold value TH1 (step ST71), the first descriptor LLI1 is not executed.

The execution of the first descriptor LLI1 of the linked list is triggered by the emission of the trigger signal SDL1 when the threshold value TH1 is reached (step ST72) which has the consequence (step ST73) of changing the threshold value of the converter 40 from TH1 to TH2.

Then in step ST74, the second descriptor LLI2 is executed, which causes the writing in the interruption register of the converter 40 of an indication intended to trigger the waking of the central processing unit 1 by the emission of the interruption IT, when the second threshold value TH2 is reached.

Then, the third descriptor LLI3 is executed in step ST75. More specifically, the emission frequency of the signal SC2 is changed in response to the control signal SC1. The value of this increase, contained in descriptor LLI3, had been stored in a register 22 of the direct memory access circuit 2.

Finally, the fourth descriptor LLI4 is executed so as to allow the transmission of the values stored in the memory 3 to the interface SPI42 (step ST76).

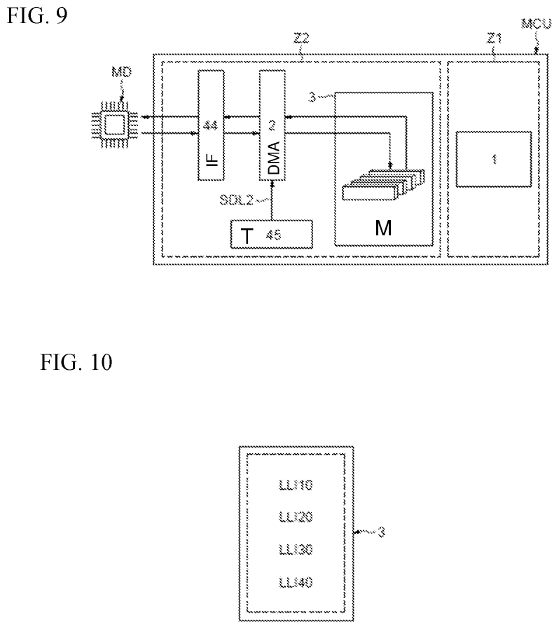

Reference is now made to FIGS. 9 to 11 to illustrate another example embodiment.

In this example, the second area Z2 includes, in addition to the direct memory access circuit 2 and the memory 3, a timer 45 and an interface 44 of the I²C type coupled to an external module, for example a sensor MD by a bus supporting the I²C communication protocol.

In this example of application, provision is made to transmit to the external sensor MD data stored in the memory 3 and to receive data from this sensor MD in order to store them in the memory 3, periodically at the rate of a signal SDL2 delivered by timer 45.

In this regard, the memory 3 include a list of four linked descriptors LLI10-LLI40 (FIG. 10).

The first descriptor LLI10 of the list is a “memory-to-memory” type descriptor intended to configure the interface 44 in emission mode while setting the number of bytes to be transmitted.

The second descriptor LLI20 is a “memory-to-peripheral” type descriptor intended to transmit the number of bytes defined by the first descriptor LLI10.

The third descriptor LLI30 is a “memory-to-memory” type configuration descriptor intended to configure the interface 44 in reception mode while setting bytes to be received.

Finally, the fourth descriptor LLI40 is a “memory peripheral” type descriptor intended to allow reception of the number of bytes defined in the third descriptor LLI30.

The timer 45 uses its own time base, that is slower than the frequency of the system clock signal SCLK.

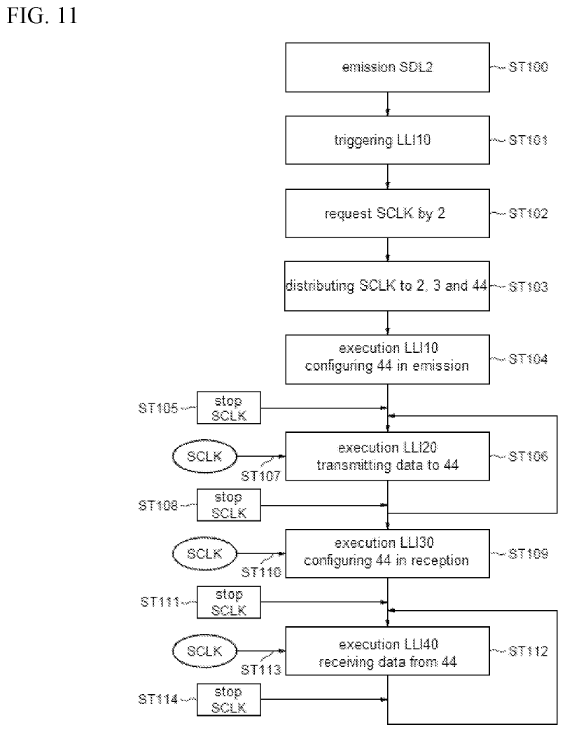

And, as illustrated in FIG. 11, when the timer 45 periodically emits the signal SDL2 (step ST100) to the direct memory access circuit 2, this causes the triggering of the first descriptor LLI10 (step ST101).

There is therefore in step ST102 a request for the system clock signal SCLK emitted by the direct memory access circuit 2 and consequently, this system clock signal SCLK is distributed in step ST103 to all elements of the second area concerned by the descriptors of the chain, namely not only the direct memory access circuit 2 but also the memory 3 and the I²C interface 44.

In step ST104, the descriptor LLI10 is executed, which configures the interface 44 in emission.

The direct memory access circuit 2 then loads the data relating to the second descriptor LLI20 then, as there is no longer any request for a clock signal SCLK, the distribution of this clock signal SCLK is stopped (step ST105).

When the interface 44 is ready to transmit data, there is again a request for the clock signal LCLK by this interface (step ST107) and the second descriptor LLI20 is executed (step ST106).

As shown by the loopback on the data transmission, the clock signal SCLK is distributed (step ST107) only for a “DMA” transfer of a datum and is not distributed (step ST108) between the “DMA” transfers.

Then, when all the data has been transmitted, the third descriptor LLI30 is loaded into the registers of the direct memory access circuit from the memory 3 and again, the distribution of the clock signal SCLK is stopped in step ST108 until the third descriptor LLI30 is executed in step ST109 so as to configure the I²C interface 44 in reception.

For this execution, the clock signal SCLK is again distributed in step ST110.

And, in step ST111, the distribution of the signal SCLK is interrupted when receiving the data by the I²C interface until the latter is ready to transfer the data to the direct memory access circuit in step ST112 by executing the descriptor LLI40. The system clock signal SCLK is then distributed (step ST113).

Here again, as shown by the loopback on the reception of the data, the clock signal SCLK is distributed (step ST113) only for a “DMA” transfer of a datum and is not distributed (step ST114) between the “DMA” transfers.

Of course, the dialog with a single sensor MD was described here. It would of course be possible to provide several sensors MD and several lists of linked descriptors similar to the list LLI10-LLI40, these lists being successively executed so as to successively interrogate the various sensors.

1. A system on chip, comprising:
a system clock device configured to generate at least one system clock signal;
a first area including a central processing unit;
a second area with elements including a direct memory access circuit, a peripheral coupled to the direct memory access circuit, and a memory containing at least one configuration descriptor of said peripheral, wherein said at least one configuration descriptor is executable by the direct memory access circuit;
wherein the system on chip has:
a first mode of operation wherein the system clock device delivers the system clock signal to all areas;
a second mode of operation wherein the system clock device does not deliver the system clock signal to any area; and
a third mode of operation wherein the system clock device distributes the system clock signal to at least part of the second area without delivering the system clock signal to other areas, and wherein the direct memory access circuit operates to configure said peripheral in response to the execution of said at least one configuration descriptor.

2. The system on chip according to claim 1, configured to switch from said second mode of operation to said third mode of operation in the presence of a system clock signal request generated by one of the elements of the second area.

3. The system on chip according to claim 2, configured to switch from the third mode of operation to the second mode of operation upon a disappearance of said system clock signal request from elements of the second area.

4. The system on chip according to claim 1, wherein the at least one configuration descriptor in the memory comprises several descriptors, each descriptor of said several descriptors containing a programmable request indication that designates, for the descriptor, the peripheral of the second area capable of transmitting a request to the direct memory access circuit.

5. The system on chip according to claim 1, wherein the at least one configuration descriptor in the memory comprises several descriptors, each descriptor of said several descriptors containing a first programmable trigger indication that indicates whether or not execution of the descriptor can be triggered by a trigger signal external to the direct memory access circuit.

6. The system on chip according to claim 5, wherein each descriptor of said several descriptors further contains a second programmable trigger indication that designates, for the descriptor, the peripheral of the second area capable of transmitting the trigger signal allowing to trigger the execution of the descriptor.

7. The system on chip according to claim 1, wherein the memory is configured to store a list of several linked descriptors sequentially addressable by the direct memory access circuit and respectively representative of actions to be executed by the direct memory access circuit.

8. The system on chip according to claim 7, wherein said list contains said at least one reconfiguration descriptor.

9. The system on chip according to claim 7, wherein the at least one configuration descriptor in the memory comprises several descriptors, each descriptor of said several descriptors containing a first programmable trigger indication that indicates whether or not execution of the descriptor can be triggered by a trigger signal external to the direct memory access circuit, and further wherein, in the third mode of operation, the direct memory access circuit is configured to trigger the sequential execution of the linked descriptors in response to the trigger signal triggering the execution of the first descriptor of the list.

10. The system on chip according to claim 1, configured to switch from said second mode of operation to said third mode of operation in the presence of a system clock signal request generated by one of the elements of the second area, wherein the at least one configuration descriptor in the memory comprises several descriptors, and wherein in the third mode of operation, the system clock device is configured, in the presence of the system clock signal request emitted by one of the elements of the second area, to distribute the system clock signal to all the elements of this second area concerned by said several descriptors.

11. The system on chip according to claim 1, wherein the direct memory access circuit has several channels, and wherein the at least one configuration descriptor in the memory comprises several descriptors, and wherein the descriptors are assigned to a single channel.

12. The system on chip according to claim 1, wherein the direct memory access circuit has several channels, and wherein the at least one configuration descriptor in the memory comprises several descriptors, and wherein the descriptors are assigned to several different channels.

13. The system on chip according to claim 1, wherein the memory is further configured to contain data to be written or read respectively originating from or intended for at least one peripheral of the second area.

14. The system on chip according to claim 1, wherein the second area comprises: at least one peripheral including an interface of an I²C type and a means for delivering at least one trigger signal; and wherein the memory contains a list of linked descriptors including:
a first configuration descriptor to configure the I²C interface in a first direction of transmission;
a second descriptor to transfer data from the memory to the I²C interface or vice versa depending on the first direction of transmission;
a third configuration descriptor to configure the I²C interface in a second direction of transmission; and
a fourth descriptor to transfer data from the I²C interface to the memory or vice versa depending on the second direction of transmission, the first descriptor of the list being able to be triggered in the presence of each trigger signal emitted by said means for delivering.

15. A method for managing the operation of a system on chip that includes a system clock device configured to generate at least one system clock signal, a first area including a central processing unit and at least one second area with elements including at least one direct memory access circuit, a peripheral coupled to the direct memory access circuit, and memory containing at least one configuration descriptor of said peripheral and executable by the direct memory access circuit, wherein the method comprises:
selectively placing the system on chip in a first mode of operation wherein the system clock device delivers the system clock signal to all areas;
selectively placing the system on chip in a second mode of operation wherein the system clock device does not deliver the system clock signal to any area; and
selectively placing the system on chip in a third mode of operation wherein the system clock device distributes the system clock signal to at least part of the second area without delivering the system clock signal to other areas, and wherein the direct memory access circuit operates to configure said peripheral in response to the execution of said at least one configuration descriptor.

16. The method according to claim 15, further comprising switching from the second mode of operation to the third mode of operation in the presence of a system clock signal request generated by one of the elements of the second area.

17. The method according to claim 16, further comprising switching from the third mode of operation to the second mode of operation upon a disappearance of said system clock signal request from elements of the second area.

18. The method according to claim 15, wherein the at least one configuration descriptor in the memory comprises several descriptors, and the method comprises for each descriptor of said several descriptors containing a programmable request indication that designates, for the descriptor, the peripheral of the second area capable of transmitting a request to the direct memory access circuit.

19. The method according to claim 15, wherein the at least one configuration descriptor in the memory comprises several descriptors, the method further comprising programming for each descriptor of said several descriptors a first trigger indication that indicates whether or not execution of the descriptor can be triggered by a trigger signal external to the direct memory access circuit.

20. The method according to claim 19, further comprising programming a second trigger indication that designates, for the descriptor, the peripheral of the second area capable of transmitting the trigger signal allowing to trigger the execution of the descriptor.

21. The method according to claim 15, further comprising storing in the memory a list of several linked descriptors sequentially addressable by the direct memory access circuit and respectively representative of actions to be executed by the direct memory access circuit.

22. The method according to claim 21, wherein said list contains said at least one reconfiguration descriptor.

23. The method according to claim 21, wherein the at least one configuration descriptor in the memory comprises several descriptors, the method further comprising:
programming for each descriptor of said several descriptors a first trigger indication that indicates whether or not execution of the descriptor can be triggered by a trigger signal external to the direct memory access circuit; and
in the third mode of operation, triggering by the direct memory access circuit the sequential execution of the linked descriptors in response to the trigger signal triggering the execution of the first descriptor of the list.

24. The method according to claim 15, further comprising:
switching from the second mode of operation to the third mode of operation in the presence of a system clock signal request generated by one of the elements of the second area;
storing several descriptors in the memory; and
in the third mode of operation, and in the presence of the system clock signal request generated by one of the elements of the second area, distributing the system clock signal to all the elements of this second area concerned by said descriptors.

25. The method according to claim 15, wherein the direct memory access circuit has several channels, and the method further comprising assigning all the descriptors to a single channel;

26. The method according to claim 15, wherein the direct memory access circuit has several channels, and the method further comprising assigning all the descriptors to several different channels.

27. The method according to claim 15, further comprising storing in the memory data to be written or read respectively originating from or intended for at least one peripheral of the second area.
